(19) United States
(12) Patent Application Publication
(10) Pub. No.: US 2022/0055926 A1
(43) Pub. Date: Feb. 24, 2022

(54) METHOD FOR THE PRECIPITATION OF ARSENIC AND HEAVY METALS FROM ACIDIC PROCESS WATER

(71) Applicant: EISENMANN ENVIRONMENTAL TECHNOLOGY GMBH, Böblingen (DE)

(72) Inventors: Jochen SCHUMACHER, Tübingen (DE); Uwe STEIN, Holzgerlingen (DE); Bodo MEISENZAHL, Kusterdingen (DE)

(21) Appl. No.: 17/286,371

(22) PCT Filed: Sep. 5, 2019
(86) PCT No.: PCT/EP2019/073762

§ 371 Date: Nov. 1, 2021

(30) Foreign Application Priority Data
Oct. 16, 2018 (DE) 10 2018 125 677.9

(51) Int. Cl. C02F 1/52

(52) U.S. Cl. CPC C02F 1/5236; C02F 2101/103; C02F 1/5209

(57) ABSTRACT

The invention relates to a method for the precipitation of arsenic and heavy metals from acidic, in particular sulphuric acid, process water (12), containing both arsenic and heavy metals, comprising a precipitation method phase (II) with a sulphide precipitation stage (C) in which arsenic and at least one primary heavy metal are precipitated together, wherein a sulphide precipitating agent (16) is added to the process water (12) such that arsenic is precipitated as arsenic sulphide and the at least one primary heavy metal is precipitated as metal sulphide. The sulphide precipitation stage (C) comprises a first sulphide precipitation step (C.1) in which a sulphide precipitating agent is added to the process water (12) in a first sulphide precipitation reactor (14), whereby an intermediate fluid (22) is generated still containing arsenic or still containing arsenic and the primary heavy metal. The intermediate fluid (22) is transferred into a second sulphide precipitation reactor (30) after the first sulphide precipitation step (C.1). The sulphide precipitation stage (C) comprises a second sulphide precipitation step (C.2) in which a sulphide precipitating agent is added to the intermediate fluid (22) in the second precipitation reactor, whereby a residual fluid (32) is generated which is substantially free from arsenic.

The invention relates to a method of precipitating arsenic and heavy metal out of acidic process water, especially containing sulfuric acid, and containing both arsenic and heavy metals, wherein the method comprises a method segment of precipitation with a sulfide precipitation stage in which arsenic and at least one primary heavy metal are coprecipitated, by adding a sulfide precipitation reagent to the process water, such that arsenic precipitates out as arsenic sulfide and the at least one primary heavy metal as metal sulfide.

Acidic process waters containing both arsenic and heavy metals are obtained in the form of wastewaters in sulfuric acid solution, for example in copper smelting or in the production of semiconductor components. But process waters in sulfuric acid that are contaminated with arsenic and heavy metals can also arise in many other industrial processes. Such process waters are also referred to as sulfuric acid-containing wash water.

Primary heavy metal shall refer merely to that heavy metal which is seen to coprecipitate with arsenic. The process water may also contain other heavy metals other than the primary heavy metal, with the primary heavy metal frequently present in the highest concentration in the process water compared to the other heavy metals. The invention is elucidated below using the abovementioned example of process waters as obtained in downstream processes in the smelting of copper.

Sulfur-containing flue gases are obtained in the smelting of copper. These are subjected to a flue gas treatment which is known per se, in which the sulfur present is converted to sulfuric acid. The impurities present are finally collected in an acidic process water, which is referred to as scrubbing solution or as scrubbing acid in the smelting of copper. Such a process water or such a scrubbing acid may contain acid in concentrations between 5% and 35%. Accordingly, the process water has a low and possibly even negative pH. As well as copper, such process water contains further (heavy) metals, such as zinc, cadmium, molybdenum, lead, selenium and mercury, and other impurities, including arsenic in particular.

Arsenic is an environmental poison, and it is therefore always the aim to process residual or waste materials obtained, such as process waters of this kind, and in so doing to free them of arsenic and compounds thereof as far as possible. A known method for this purpose, for example, is to precipitate arsenic as the sulfide from scrubbing acids.

DE 34 18 241 A1, for example, discloses a method of removing arsenic from waste sulfuric acids, in which an aqueous solution of sodium sulfide NaS₂ and sodium hydrogen sulfide NaHS, in which the amount of sodium sulfide is set to a superstoichiometric level relative to the arsenic content of the waste acid, is used as sulfidizing agent in a hydrogen sulfide atmosphere. Such precipitation reactions also precipitate copper present in the process water and other heavy metals present as the sulfide. The precipitated sulfides, i.e. arsenic sulfide and copper sulfide and the sulfides of other heavy metals present, are filtered out of the filter mixture obtained after the precipitation reaction, and the filtercake is subsequently disposed of.

In the case of such a removal of arsenic, the residual concentration of arsenic in the filtrate ultimately obtained should be as small as possible, and in the optimal case should be below 1 mg/L. In the known methods, this is achieved by a high dosage of sulfide precipitation reagent.

This results in a considerable concentration of hydrogen sulfide in the output air, which may be up to 2% by volume.

Furthermore, in known precipitation methods, arsenic sulfide precipitates out in the form of a kind of flakes, which are notable for a low density and small flake size, but a comparatively high volume overall. These flakes show a very low tendency to sediment and are additionally mechanically unstable. In the filtering operation, the arsenic sulfide flakes are therefore additionally slightly pulverized, resulting in a kind of lubricant film or sludge that blocks a filter in the form of a filter cloth, for example, even after a short time, which means that a continued or effective filtering operation is then no longer possible. The filter consequently has to be changed after taking up only small amounts of sulfides and a correspondingly short service life, which makes the filtering operation laborious, time-consuming and costly.

It is an object of the invention to provide a method of the type specified, which enables more effective separation of arsenic and at least one heavy metal from acidic process water by comparison.

This object is achieved, in a method of the type specified at the outset, in that
a) the sulfide precipitation stage comprises a first sulfide precipitation step in which sulfide precipitation reagent is added to the process water in a first sulfide precipitation reactor, producing an intermediate liquid still containing arsenic or still containing arsenic and primary heavy metal;
b) the intermediate liquid, after the first sulfide precipitation step, is transferred into a second sulfide precipitation reactor;
c) the sulfide precipitation stage comprises a second sulfide precipitation step in which sulfide precipitation reagent is added to the intermediate liquid in the second precipitation reactor, producing a residual liquid that has been largely freed of arsenic.

It has been recognized in accordance with the invention that it is possible by means of a sulfide precipitation stage having two steps to arrive at particularly low arsenic concentrations in an efficient and resource-saving manner.

In order to be able to undertake the dosage of sulfide precipitation reagent in a controlled manner in the first sulfide precipitation step, it is favorable when, before the first sulfide precipitation step, an analysis of the process water at least with regard to the arsenic content is conducted in an analysis stage.

By adding sulfide precipitation reagent in a substoichiometric amount at least based on the arsenic content of the process water in the first sulfide precipitation step, it is first possible to effect a preliminary or coarse precipitation of arsenic and primary heavy metal present and of any further heavy metals.

It is advantageous here when sulfide precipitation reagent is added in a substoichiometric ratio of 1:1.2 to 1:1.01, preferably in a ratio of 1:1.15 to 1:1.01, more preferably in a ratio of 1:1.1 to 1:1.01 and especially preferably in a ratio of 1:1.05, based on the arsenic content of the process water.

In order also to be able to undertake the dosage of sulfide precipitation reagent in a controlled manner in the second sulfide precipitation step, it is favorable that, before the second sulfide precipitation step, an analysis of the intermediate liquid at least with regard to the arsenic content is conducted in an analysis stage.

In order to be able to arrive at particularly low arsenic concentrations in the remaining residual liquid, it is favorable when, in the second sulfide precipitation step, sulfide precipitation reagent is added in a superstoichiometric amount at least based on the arsenic content of the intermediate liquid.

It is advantageous here to add sulfide precipitation reagent in a superstoichiometric ratio of 1.5:1, in a ratio of 2:1, in a ratio of 3:1 or in a ratio of at least 4:1 or in a ratio of 20:1, based on the arsenic content of the intermediate liquid.

Preferably,
a) after the first sulfide precipitation step at least one separation stage is conducted, in which precipitated sulfides are separated from the intermediate liquid;
and/or
b) after the second sulfide precipitation step at least one separation stage is conducted, in which precipitated sulfides are separated from the residual liquid.

As a result of the initially substoichiometric precipitation in the first sulfide precipitation step, the resultant precipitation sludge has better filtration properties than in the case of a direct superstoichiometric precipitation. The precipitated sulfides can therefore be separated effectively from the intermediate liquid with a filter unit that especially comprises a filter cloth.

It is advantageous when the first sulfide precipitation reactor and/or the second precipitation reactor and/or one or more separation stages are supplied with air, especially conditioned air. This air can displace hydrogen sulfide from the gas space of the reactors or the separation stages, such that hydrogen sulfide present can be effectively removed.

It is particularly effective when hydrogen sulfide from at least one of the method stages and method steps in which hydrogen sulfide is released is used as sulfide precipitation reagent or for production of sulfide precipitation reagent for the first sulfide precipitation step. In this way, by comparison with known methods, it is possible to save sulfide precipitation reagent to a high degree, which allows the removal of arsenic to be performed in a resource-sparing manner and at reduced cost.

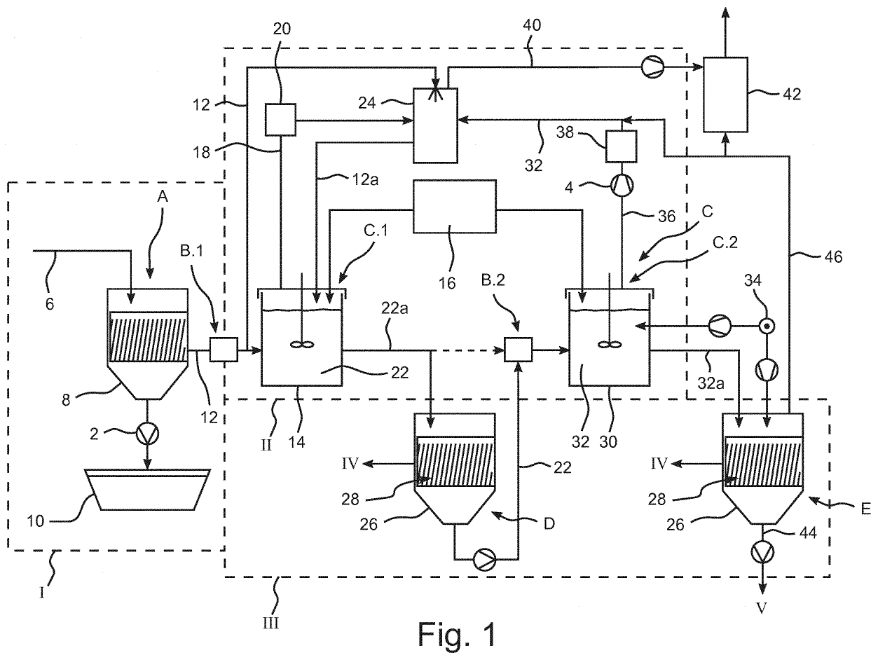

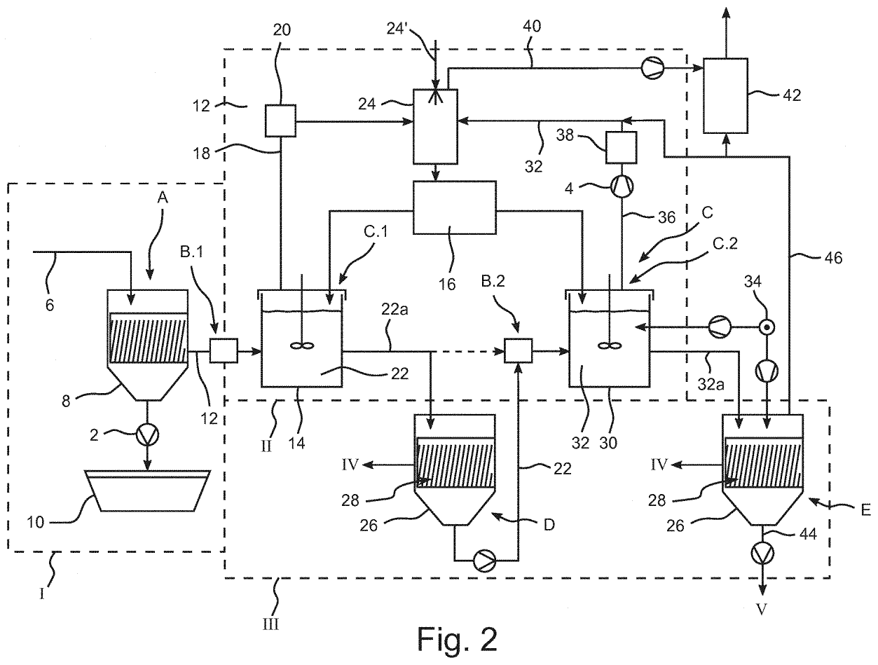

A working example of the method of the invention is elucidated hereinafter with reference to FIGS. 1 and 2, which are schematic illustrations of two variants of the method.

A plurality of pumps and fans are shown therein, of which, for the sake of clarity, only one pump is identified as 2 and only one fan as 4. Requisite pumps or fans are not shown in all conduits. Conveying conduits in the process diagram illustrated by arrows, the direction of the arrow indicating the respective conveying direction. The conveying conduits have not been individually labeled. The pumps and fans control the respective volume flow rate of the fluids being conveyed in each case. Valves may also be present in the conduits, which are not shown separately for the sake of clarity.

In a pretreatment segment of the method identified as I, a pretreatment is effected, in which a scrubbing acid 6 obtained in the flue gas treatment mentioned at the outset is first prepared for the separation of arsenic and copper. For example, it is especially possible to precipitate and remove dust particles and undissolved arsenic trioxide particles entrained by the scrubbing acid 6 using precipitation aids as known per se. For this purpose, the scrubbing acid, in a separation or filter stage A, is guided via a feed conduit to a filter unit 8. The solids separated out are transferred into a collecting vessel 10 and thence sent to disposal. The filtrate obtained then forms that process water 12 which is to be freed of arsenic and heavy metals, primarily of copper.

The composition of the process water 12 is determined in an analysis stage B.1 at least with regard to the arsenic content, and in the present working example also with regard to the copper content and/or the sulfuric acid concentration. Typically, process waters or scrubbing acids as considered here have a sulfuric acid content between 1% and 35% and contain between 3 g/L and 18 g/L of arsenic. The copper content is generally of the order of between 0.1 g/L and 12 g/I.

Method segment I for pretreatment may comprise further treatment stages or steps as well as the filter stage A, but this is of no further interest here.

In the present working example, copper defines the primary heavy metal. The process water 12 that has been freed of dust is strongly acidic and has a pH=0.

The process water 12 is then sent to a precipitation segment II of the method in which arsenic and the primary heavy metal, i.e. copper in the present case, are coprecipitated in a sulfide precipitation stage C, optionally together with other heavy metals present. The sulfide precipitation stage C comprises a first sulfide precipitation step C.1 and a second sulfide precipitation step C.2.

In the first sulfide precipitation step C.1, a sulfide precipitation reagent 16 is added to the process water 12 in a first sulfide precipitation reactor 14 while stirring. A corresponding stirrer system is illustrated merely schematically in the figure and is not given its own reference numeral.

The sulfide precipitation reagent 16 used is in practice inorganic sulfide, for example sodium hydrogen sulfide NaHS. But other sulfide precipitation reagents, for example disodium sulfide, are also an option. It is also possible to use hydrogen sulfide that may in turn also be produced by means of hydrogen sulfide-producing bacteria as known per se. The sulfide precipitation reagent 16 is added to the process water 12 at a temperature of about 40° C. to 80° C.

Sulfide precipitation reagent 16 is added in a substoichiometric amount based on the arsenic content of the process water 12. Sulfide precipitation reagent 16 is added here in substoichiometric ratio of 1:1.2 to 1:1.01, preferably in a ratio of 1:1.15 to 1:1.01, more preferably in a ratio of 1:1.1 to 1:1.01 and especially preferably in a ratio of 1:1.05, based on the arsenic content of the process water 12.

Output air 18 that arises in the first sulfide precipitation reactor is monitored for the presence of hydrogen sulfide by means of a measurement device 20 as known per se, with optional detection of the hydrogen sulfide concentration present. The sulfide precipitation reagent 16 should always be added to the first sulfide precipitation reactor 14 in such a way that no hydrogen sulfide is formed. If hydrogen sulfide is nevertheless detected in the output air 18, the addition of sulfide precipitation reagent 16 is reduced correspondingly. The control of the amount of the sulfide precipitation reagent 16 to be added thus depends firstly on the data from the analysis stage B.1 and the data from the measurement device 20.

The output air 18 is sent to a scrubbing device 24, which may, for example, be a spray scrubber known per se, which is also supplied with process water 12. The scrubbing device 24 is discussed once again further down.

Alternatively or additionally to the stirrer system, it is also possible to provide an injector system that introduces process water 12 and/or sulfide precipitation reagent 16 into the first sulfide precipitation reactor 14. Both alternatives enable energy-efficient mixing of the components and an efficient precipitation reaction.

The precipitation of arsenic sulfide and heavy metal sulfide, primarily of copper sulfide CuS, in the first sulfide precipitation reactor 14 produces an intermediate liquid 22. This precipitation is a kind of preliminary precipitation of arsenic sulfide and heavy metal sulfide(s). The intermediate liquid 22 produced after addition of the sulfide precipitation reagent 16 still contains dissolved arsenic and heavy metal(s), especially copper.

The intermediate liquid 22 is transferred together with the precipitated sulfides as mixture 22a to a separation segment III in which the precipitated sulfides are separated from the intermediate liquid 22. For this purpose, one or more separation stages are conducted. The figure illustrates one separation stage D by way of illustration, in which the precipitation products present are separated from the intermediate liquid 22 by means of a filter unit 26, such that the intermediate liquid 22 remains as filtrate and forms a filtercake which is not shown specifically. In the present working example, the mixture is run through a filter cloth 28 for this purpose.

The filtercake is collected and can subsequently be sent to a disposal step IV and disposed of in a manner known per se.

The intermediate liquid 22 is then sent to the second sulfide precipitation step C.2 of the precipitation segment II of the method, for which purpose it is transferred into a second sulfide precipitation reactor 30 therein.

In a modification, the mixture 22a of intermediate liquid 22 and the precipitated sulfides can also be transferred to the second sulfide precipitation step C.2 directly from the first sulfide precipitation step C.1 even without passing through the separation segment III and hence without separation stage D, which is indicated by a dotted arrow. In this case, any precipitation products already obtained are at least partly transferred into the second sulfide precipitation reactor 30 as well.

The composition of the intermediate liquid 22 which is pumped into the second sulfide precipitation reactor 28 is determined at least with regard to the arsenic content, and in the present working example also with regard to the copper content and/or the sulfuric acid concentration, in a second analysis stage B.2. Typically, the intermediate liquid 22 still contains between 10 mg/L and 200 mg/L of arsenic. The copper content is generally of the order of between 1 mg/L to 10 mg/L. The method can also be conducted reliably when one or both of analysis stages B.1 and B.2 are dispensed with.

In the second precipitation step C.2, sulfide precipitation reagent 16 is then added to the intermediate liquid 22 in the second sulfide precipitation reactor 30 while stirring. The second sulfide precipitation reactor 30 works as a reactor for residual precipitation; a corresponding stirrer system is again shown merely schematically in the figure and is not given its own reference numeral. In the second sulfide precipitation reactor 30 as well, it is possible to provide an injector system alternatively or additionally to the stirrer system; this can introduce intermediate liquid 22 and/or sulfide precipitation reagent 16 into the second sulfide precipitation reactor 30.

Useful sulfide precipitation reagents 16 are again the above-described sulfide precipitation reagents. In the second sulfide precipitation reactor 30, the sulfide precipitation reagent 16 is also added at temperatures between 40° C. and 80° C.

The temperature may be lower both in the first sulfide precipitation reactor 14 and in the second sulfide precipitation reactor 30, and may be room temperature, for example.

Based on the arsenic content of the intermediate liquid 22, sulfide precipitation reagent 16 is added in a superstoichiometric amount in the second precipitation step C.2, in order to ensure complete precipitation of the arsenic present as arsenic sulfide. In addition, heavy metals still present, primarily copper, precipitate out as sulfides. This produces a residual liquid 32 that has been largely freed of arsenic. Heavy metals, especially cadmium and mercury, may still be present. The sulfide precipitation reagent 16 is added in a superstoichiometric amount and especially in a ratio of 1.5:1, in a ratio of 2:1, in a ratio of 3:1 or in a ratio of at least 4:1, based on the arsenic content of the intermediate liquid 22. It is optionally also possible to set considerably superstoichiometric ratios. For example, the ratio may be up to 20:1.

Air 34 is additionally blown into the second sulfide precipitation reactor 30, which firstly assists the mixing in the second sulfide precipitation reactor 30 and secondly displaces hydrogen sulfide formed in the second sulfide precipitation reactor 30. The air 34 is in practice conditioned with regard to moisture content and temperature and freed of troublesome impurities.

In the second sulfide precipitation reactor 30, output air 36 containing hydrogen sulfide is thus formed. This output air 36, just like the output air 18 from the first sulfide precipitation reactor 14, is fed to the scrubbing device 24, where the hydrogen sulfide content is ascertained with the aid of a further measuring device 38. Even if the waste air 18 does not entrain any hydrogen sulfide from the first sulfide precipitation reactor 14, the process water 12 which is introduced into the scrubbing device 24 is consequently always contacted with hydrogen sulfide therein.

In this way, the process water 12 scrubs hydrogen sulfide out of the output air 18 and/or the output air 36, and is run thereafter as hydrogen sulfide-admixed process water 12a into the first sulfide precipitation reactor 14. The amount of hydrogen sulfide that has been introduced into the first sulfide precipitation reactor 14 in this way is taken into account in controlling the amount of the sulfide precipitation reagent 16 to be added to the first sulfide precipitation reactor 14. The addition of sulfide precipitation reagent 16 to the first sulfide precipitation reactor 14 in the present working example is thus based on the data from the analysis stage B.1, the measurement device 20 and the further measurement device 38.

It is optionally possible to guide the hydrogen sulfide through sodium hydroxide solution NaOH in the scrubbing device 24, which produces sodium hydrogen sulfide NaHS, which is then guided into the first sulfide precipitation reactor 14 as an aqueous solution as sulfide precipitation reagent 16. This is shown in FIG. 2, in which NaOH is labeled 24′, and the scrubbing device 24 produces the sulfide precipitation reagent 16, which is then guided as described above into the first sulfide precipitation reactor 14 and/or the second sulfide precipitation reactor 30.

The sulfide precipitation reagent which is added to the process water 12 in the first sulfide precipitation reactor 14 may thus firstly comprise the sulfide precipitation reagent identified by reference numeral 16, and secondly the hydrogen sulfide that arrives in the scrubbing device 24 or sulfide precipitation reagent produced therefrom.

In a modification which is not shown separately, air 34 is additionally blown into the first sulfide precipitation reactor 14, in order to displace hydrogen sulfide formed there, which in this way is pushed to the scrubbing device 24 with corresponding output air. In addition, the mixing can be promoted by air when it is blown into the process water 12.

In the scrubbing device 24, output air 40 that has been largely freed of hydrogen sulfide is formed, which is sent to an output air scrubber 42 for further cleaning, as likewise known per se. Particularly any possible residual hydrogen sulfide constituents are removed therein.

The residual liquid 32 is transferred together with the precipitated sulfides as residual mixture 32a from the second sulfide precipitation reactor 30 to one or more further separation stages of the separation segment III, in which the precipitated sulfides are separated from the residual liquid 32. For these purposes, again by way of illustration, the figure illustrates a separation stage E corresponding to the separation stage D for the mixture 22a, and correspondingly comprising a filter unit 26 with filter cloth 28, such that the residual liquid 32 remains as a filtrate and a filtercake, not individually identified, is again formed. The filtercake is likewise collected and can subsequently be fed to the disposal segment IV addressed in the separation stage D, and especially incinerated.

The residual liquid 32 separated off in the filter unit 26 of the separation stage E has a residual arsenic concentration of less than 1 mg/L and can be used in chemical processes as technical grade acid 44, in the present working example as technical grade sulfuric acid. For this purpose, it is conveyed to a further utilization V. The acid 44 is optionally first subjected to further processing steps, as known per se.

Air 34 is additionally also blown into the filter unit 26 of the separation stage E, which to displace hydrogen sulfide still present in the atmosphere of the separation stage E or any that is still being formed. This is either pushed, as output air 46, via a corresponding conduit into the scrubbing device 24, by means of which it is also possible to utilize this hydrogen sulfide as a supplementary sulfide precipitation reagent, or run into the output air scrubber 42.

In general terms, hydrogen sulfide from at least one of the method stages, of method stages D and E in the present case, and of the method steps, of the sulfide precipitation steps C.1 and C.2 in the present case, in which hydrogen sulfide is released, is used as sulfide precipitation reagent or for production of sulfide precipitation reagent for the first sulfide precipitation step.

In a modification which is not shown individually, hydrogen sulfide concentrations of the output air 36 from the second sulfide precipitation reactor 30 and the output air 46 from the separation stage E are ascertained separately by individual measurement devices. In this case, it is especially possible to adjust the dosage of sulfide precipitation reagent 16 to the second sulfide precipitation reactor 30 depending on the hydrogen sulfide content of the output air 36 therein, in order to avoid excessively superstoichiometric dosage if desired.

In a further modification not shown individually, air 34 is also blown into the filter unit 26 of separation stage D, and output air formed therein is run through a measurement device for determination of the hydrogen sulfide content to the scrubbing device 24. Correspondingly, this output air or this hydrogen sulfide contributes to setting of the dosage of the sulfide precipitation reagent 16 to the first sulfide precipitation reactor 14.

Overall, the recovery or utilization of the hydrogen sulfide H₂S formed in each case can lower the amount of sulfide precipitation reagent 16 required by up to 90% or more, based on the amount that would be necessary without utilization of the hydrogen sulfide formed.

1. A method of precipitating arsenic and heavy metal out of acidic process water containing both arsenic and heavy metals, where the method comprises:
a method step of precipitation with a sulfide precipitation stage in which arsenic and at least one primary heavy metal are coprecipitated by adding a sulfide precipitation reagent to the process water such that arsenic precipitates out as arsenic sulfide and the at least one primary heavy metal as the metal sulfide,
wherein
a) the sulfide precipitation stage comprises a first sulfide precipitation step in which sulfide precipitation reagent is added to the process water in a first sulfide precipitation reactor, producing an intermediate liquid still containing arsenic or still containing arsenic and primary heavy metal;
b) the intermediate liquid, after the first sulfide precipitation step, is transferred into a second sulfide precipitation reactor; and
c) the sulfide precipitation stage comprises a second sulfide precipitation step in which sulfide precipitation reagent is added to the intermediate liquid in the second precipitation reactor, producing a residual liquid that has been largely freed of arsenic.

2. The method as claimed in claim 1, wherein, before the first sulfide precipitation step, an analysis of the process water at least with regard to the arsenic content is conducted in an analysis stage.

3. The method as claimed in claim 1, wherein, in the first sulfide precipitation step, sulfide precipitation reagent is added in a substoichiometric amount at least based on the arsenic content of the process water.

4. The method as claimed in claim 3, wherein sulfide precipitation reagent is added in a substoichiometric ratio of 1:1.2 to 1:1.01, based on the arsenic content of the process water.

5. The method as claimed in claim 1, wherein, before the second sulfide precipitation step, an analysis of the intermediate liquid at least with regard to the arsenic content is conducted in an analysis stage.

6. The method as claimed in claim 1, wherein, in the second sulfide precipitation step, sulfide precipitation reagent is added in a superstoichiometric amount at least based on the arsenic content of the intermediate liquid.

7. The method as claimed in claim 6, wherein sulfide precipitation reagent is added in a superstoichiometric ratio of 1.5:1, based on the arsenic content of the intermediate liquid.

8. The method as claimed in claim 1, wherein
a) after the first sulfide precipitation step at least one separation stage is conducted, in which precipitated sulfides are separated from the intermediate liquid; and/or
b) after the second sulfide precipitation step at least one separation stage is conducted, in which precipitated sulfides are separated from the residual liquid.

9. The method as claimed in claim 8, wherein the first sulfide precipitation reactor and/or the second precipitation reactor and/or one or more separation stages are supplied with air.

10. The method as claimed in claim 1, wherein hydrogen sulfide from at least one of the process stages and process steps in which hydrogen sulfide is released is used as sulfide precipitation reagent or for production of sulfide precipitation reagent for the first sulfide precipitation step.

11. The method of claim 1, wherein the acidic process water contains sulfuric-acid.

12. The method as claimed in claim 3, wherein sulfide precipitation reagent is added in a substoichiometric ratio of 1:1.15 to 1:1.01, based on the arsenic content of the process water.

13. The method as claimed in claim 3, where sulfide precipitation reagent is added in a substoichiometric ratio of 1:1.1 to 1:1.01, based on the arsenic content of the process water.

14. The method as claimed in claim 3, wherein sulfide precipitation reagent is added in a sub stoichiometric ratio of 1:1:05, based on the arsenic content of the process water.

15. The method as claimed in claim 6, wherein sulfide precipitation reagent is added in a superstoichiometric ratio of 2:1, based on the arsenic content of the intermediate liquid.

16. The method as claimed in claim 6, wherein sulfide precipitation reagent is added in a superstoichiometric ratio of 3:1, based on the arsenic content of the intermediate liquid.

17. The method as claimed in claim 6, wherein sulfide precipitation reagent is added in a superstoichiometric ratio of at least 4:1, based on the arsenic content of the intermediate liquid.

18. The method as claimed in claim 6, wherein sulfide precipitation reagent is added in a superstoichiometric ratio of 20:1, based on the arsenic content of the intermediate liquid.
